(19) United States
(12) Patent Application Publication
(10) Pub. No.: US 2015/0278527 A1
(43) Pub. Date: Oct. 1, 2015

(54) Self-Test of a Physical Unclonable Function

(71) Applicant: SIEMENS AKTIENGESELLSCHAFT, München (DE)

(72) Inventor: Rainer Falk, Poing (DE)

(21) Appl. No.: 14/432,201

(22) PCT Filed: Aug. 8, 2013
(86) PCT No.: PCT/EP2013/066653

§ 371 Date: Mar. 28, 2015

(30) Foreign Application Priority Data
Sep. 28, 2012 (DE) 10 2012 217 716.7

(51) Int. Cl. G06F 21/57; H04L 9/32

(52) U.S. Cl. CPC G06F 21/577; H04L 9/3278; G06F 2221/034

(57) ABSTRACT

The invention relates to a circuit unit (1) comprising a Physical Unclonable Function (6), hereinafter referred to as PUF (6), a verification unit (5) and an information storage device (7) for storing at least one Challenge-Response-Pair (CR1); wherein the Challenge-Response-Pair (CR1) comprises a Challenge Information (C1) and a Response Information (R1) associated therewith, and wherein the verification unit (5) is embodied and/or adapted, in order to bring about an input of the challenge information (C1) into the PUF (6) and to use a PUF Response (PR1) created thereafter by the PUF (6) and the Response Information for a comparison, and in dependence of the result of the comparison release or restrict a use of the PUF (6).

The present invention relates to the technical field of self-tests of physical unclonable functions.

PUF-based Secure Test Wrapper Design for Cryptographic SoC Testing http://www.cosic.esat.kuleuven.be/publications/article-2165.pdf describes the use of a PUF to protect access to a test interface of an IC. The generally known self-test (BIST—built-in self-test), by means of which a subassembly tests its correct functionality itself and provides a corresponding status message, is also mentioned.

Tim Tuyls, Boris Skoric: Strong Authentication with Physical Unclonable Functions, in Security, Privacy, and Trust in Modern Data Management, Springer, 2007, p. 133 ff. discloses the practice of constructing a sensor for detecting physical manipulation/tampering from a PUF. For this purpose, the PUF monitors whether the expected response values are returned in response to known challenges during operation. Physical manipulation, in which the PUF is physically destroyed or modified, can be detected by virtue of the expected response no longer being provided (see page 135 which describes the fact that real-time tamper detection can be achieved if the PUF is an integrated PUF which has access to the enrolment data). The PUF then regularly carries out self-tests and takes the appropriate action, for example triggering of an alarm or switching-off as soon as a response does not match the enrolment data.

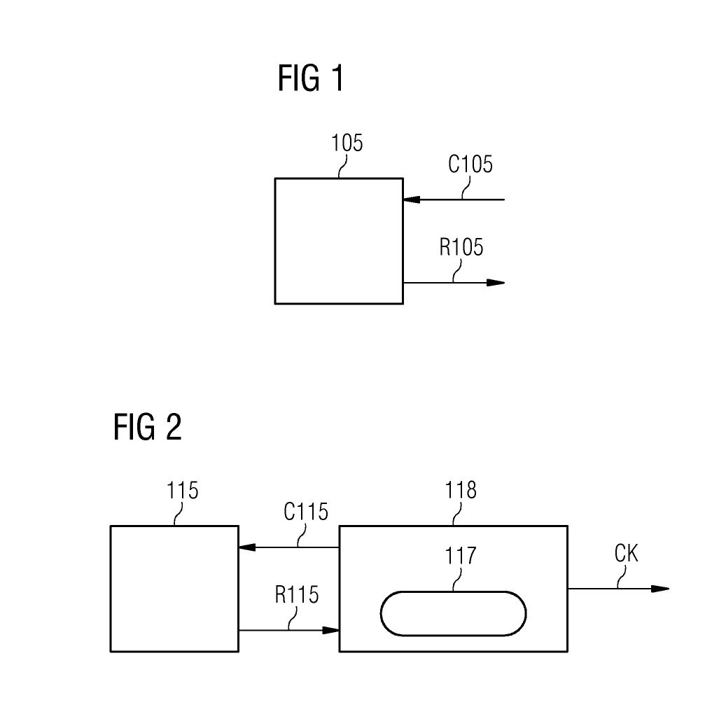

FIG. 1 shows a physical unclonable function 105 (often also simply called PUF) according to the prior art. An item of challenge information C105 can be input to the PUF. The PUF 105 then generates an item of response information R105.

A PUF can also be used to form a cryptographic key. FIG. 2 shows a corresponding basic scheme according to the prior art with a PUF 115, to which an item of challenge information C115 can be input, whereupon the PUF 115 outputs an item of response information R115. In this case, a fuzzy key extractor 118 (also called FKE) determines a cryptographic key CK by means of the PUF 115 using auxiliary data 117.

The lecture notes http://www.sec.in.tum.de/assets/lehre/ss10/sms/sms-kap6-rfid-teil2.pdf provide an overview of physical unclonable functions (PUF).

Physical unclonable functions are known in order to reliably identify objects using their intrinsic physical properties. In this case, a physical property of an object (for example a semiconductor IC) is used as an individual “fingerprint”. The authentication of an object is based on an associated response value being returned on the basis of a challenge value by a PUF function defined by physical properties. Physical unclonable functions (PUF) provide a space-saving and therefore cost-effective possibility for authenticating a physical object using its intrinsic physical properties. For this purpose, the PUF determines an associated response value for a predefined challenge value on the basis of object-specific physical properties of the object. A tester wishing to authenticate an object can identify the object as the original object by comparing the similarity of the available response values and the response values provided by the authenticated object in the case of known challenge-response pairs. Further uses of a PUF are known, in particular the on-chip determination of a cryptographic key using a PUF.

Examples of PUFs are a delay PUF/arbiter PUF, SRAM PUF, ring oscillator PUF, bistable ring PUF, flip-flop PUF, glitch PUF, cellular non-linear network PUF or a butterfly PUF.

Special PUFs, for example in the case of ICs, can be applied to the IC (coating PUF, optical PUF) and can thereby implement a layer above the IC, which layer, on the one hand, prevents access to internal structures (below it) and is destroyed during removal. However, this has the disadvantage that special production methods are required. Attacks which do not damage the protective layer (for example which are effected from the opposite side or from the side) are also possibly not detected.

The PUF raw data (response) must generally also be post-processed in order to compensate for statistical fluctuations of the PUF response (for example by means of a forward error correction or a feature extraction in a manner corresponding to conventional fingerprint authentication). This is also known under the term “fuzzy key extractor” (see, for example, http://www.iacr.org/archive/eurocrypt2004/30270518/DRS-ec2004-final.pdf; http://www.cs.ucla.edu/-rafail/PUBLIC/89.pdf).

It is known practice to verify the implementation of a cryptographic algorithm by an independent verifier, for example Cryptographic Algorithm Validation Program (CAVP), see, for example, http://csrc.nist.gov/groups/STM/cavp/index.html and http://www.atsec.com/us/cryptographic-algorithm-testing-lab-resources.html.

It is known practice for a device to carry out a self-test. Specifically, it is known practice for a self-check of the cryptographic functionality to be carried out when a device is started and/or recurrently. The use of the cryptographic functionality is enabled only in the positive case. See, for example, http://spiderman-2.laas.fr/WDSN08/2ndWDSN08(LAAS)_files/Texts/WDSN08-08-DiNatale.pdf for the resource-efficient built-in self-test of a symmetrical cryptographic algorithm. Some standards such as FIPS140-2 also require a self-test of the cryptographic functions (see http://csrc.nist.gov/publications/fips/fips140-2/fips1402.pdf, section 4.9). Known methods are stated in section 4.9 of FIPS140-2.

In the case of physical random number generators, evaluation by means of statistical tests is known (https://www.bsi.bund.de/SharedDocs/Downloads/DE/BSI/Zertifizierung/Interpretationen/ais31_pdf.pdf?_blob=publicationFile). It is known practice to test the quality of the physically generated random numbers during ongoing operation and to stop the provision of random numbers in the event of an error (http://www.ibbergmann.org/Physikalischer_Zufallssignalgenerator.pdf).

It is known practice to derive a key from a PUF. The key can be uniquely generated even in the case of statistical fluctuations by means of error correction methods (http://members.home.nl/skoric/security/PUF_KeyExtraction.pdf). The practice of reserving some challenge values in order to thereby calibrate the PUF is also described here. A reviser (verifier) uses these known calibration values to verify whether the reader (reviser) and the PUF are correctly aligned. Actual authentication is carried out only in the case of a sufficiently small difference between the measured calibration values and the stored calibration values. This especially concerns optical PUFs in which a reader and the optical PUF must be aligned with sufficient accuracy in order to obtain the expected result.

Various error correction and error detection methods are known, for example BCH codes or turbo codes.

They can also be used to determine the Hamming distance, that is to say the number of different bits.

It is proven practice for a cryptographic security component to carry out a self-test during operation, with the result that it cannot be used in the event of a malfunction. A physical unclonable function has special requirements here on account of its statistical behavior in comparison with a conventional cryptographic algorithm, with the result that the known self-test methods cannot be used.

A physical unclonable function is an elementary security functional module which can be used to carry out authentication, for example, or to determine a cryptographic key.

There is therefore a need for a secure PUF. The object of the present invention is to meet this need.

This object is achieved by the combinations of features described in the independent claims. Advantageous refinements of the invention are stated in further claims.

A first aspect of the invention proposes a circuit unit. The circuit unit comprises a physical unclonable function (PUF), a testing unit and an information memory for storing at least one challenge-response pair. The challenge-response pair comprises an item of challenge information and an associated item of response information. The testing unit is configured and/or adapted to prompt an input of the challenge information to the PUF and to use a PUF response thereto, which is generated by the PUF, and the response information for a comparison. The testing unit enables or restricts use of the PUF on the basis of the comparison result.

According to another aspect, the invention relates to a method for carrying out a self-test of a PUF included in a circuit unit. The circuit unit comprises a PUF, a testing unit and an information memory for storing at least one challenge-response pair. In this case, the challenge-response pair comprises an item of challenge information and an associated item of response information. During the method, the challenge information is input to the PUF. A PUF response thereto, which is generated by the PUF, and the response information are used for a comparison by the testing unit. Use of the PUF is enabled or restricted on the basis of the comparison result.

Preferred embodiments of the invention are explained in more detail below, for example, using the figures, in which:

FIG. 1 shows a PUF according to the prior art;

FIG. 2 shows a basic scheme according to the prior art which can be used to determine a cryptographic key using a PUF;

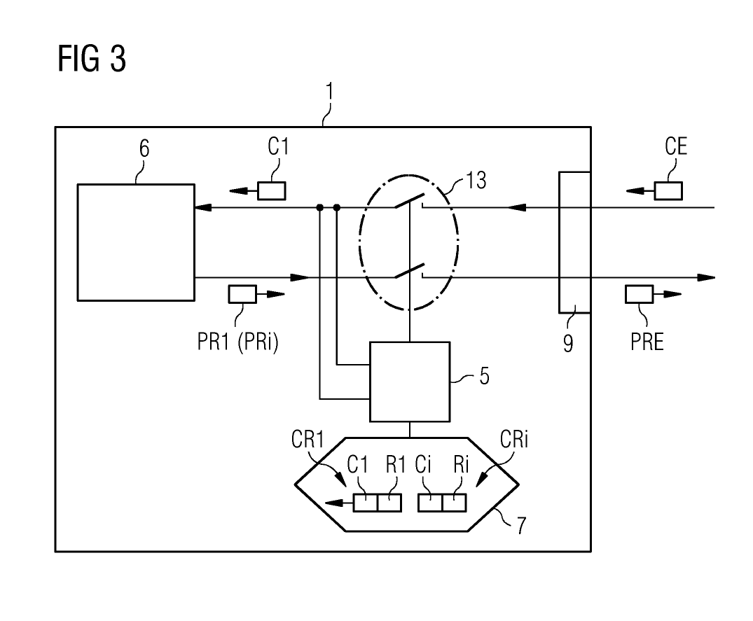

FIG. 3 shows a circuit unit according to one preferred embodiment of the invention; and

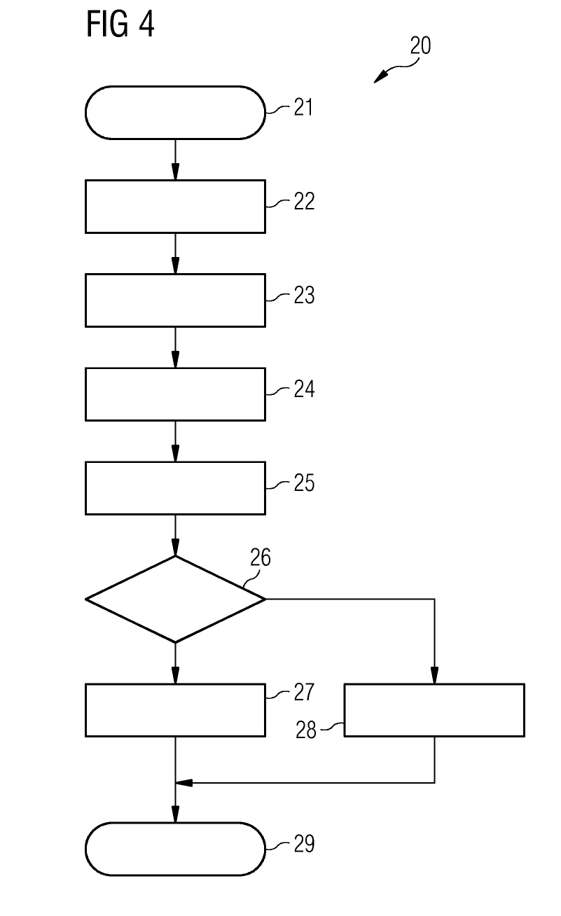

FIG. 4 shows a flowchart for one preferred embodiment of the inventive method.

FIG. 3 shows a circuit unit 1 according to one preferred embodiment of the invention. The circuit unit 1 comprises a physical unclonable function 6, a testing unit 5 and an information memory 7 for storing at least one challenge-response pair CR1. Further challenge-response pairs CRi can be storable in the information memory 7. The physical unclonable function 6 is also called PUF 6 below. A challenge-response pair CR1 or CRi typically comprises an item of challenge information C1 or Ci and an associated item of response information R1 or Ri. The testing unit 5 is configured and/or adapted to prompt an input of the challenge information C1 or a plurality of items of challenge information Ci to the PUF 6. The testing unit 5 is configured and/or adapted to use the PUF response PR1 thereto, which is generated by the PUF 6, and the response information R1 for a comparison. The testing unit 5 is also configured and/or adapted to enable or restrict use of the PUF 6 on the basis of the comparison result. The PUF 6 can be enabled or restricted, for example, using a switch 13 which is illustrated in FIG. 3.

FIG. 3 therefore shows a physical PUF 6, for example according to the prior art, and a testing unit 5 which uses stored reference data CR1, CRi to test the physical PUF 6 before access to the PUF from the outside is allowed (symbolically illustrated by switch 13).

The circuit unit 1 is preferably an integrated circuit 1. This increases the protection against attacks. However, it is also conceivable for the circuit unit 1 to be a combination of integrated circuits forming a permanent unit using suitable means, for example molded into a suitable plastic or another suitable material.

The circuit unit 1 preferably comprises a communication interface 9 which can be used to access the PUF 6 from the outside by means of an external device. As illustrated in FIG. 3, when a communication interface 9 is enabled, an item of external challenge information CE can be input to the PUF 6 using the communication interface 9. The PUF 6 then outputs a PUF response PRE intended for outside for the external device via the communication interface 9.

The use of the PUF 6 can preferably be enabled or restricted by directly enabling or blocking access to the PUF 6. In this case, the use of the PUF 6 can be enabled or restricted, for example, by enabling or blocking the communication interface 9. The communication interface 9 can be blocked, for example. A further function block (for example an RF communication function block of an RFID chip with PUF-based authentication or an I2C interface) which is integrated in the circuit unit or is external can be blocked, for example.

According to another preferred embodiment, the use of the PUF 6 can be enabled or restricted using a cryptographic parameter determined by the PUF 6, preferably by virtue of a cryptographic key being able to be determined by a fuzzy key extractor. The output of the key can be blocked, for example. In other words, PUF access can therefore be blocked using such a function in a subsequent processing step, as when directly blocking the external communication interface 9, for example. A fuzzy key extractor function block for deriving a cryptographic key on the basis of PUF response values or a key output function block for providing a cryptographic key can be blocked, for example.

According to another preferred embodiment, the testing unit 5 determines a degree of match during the comparison. The degree of match is compared with a threshold value. If the determined degree of match reaches or exceeds the threshold value, the use of the PUF 6 is enabled or restricted. It goes without saying that, with a suitable selection as well, the suitable measures can be carried out even if the threshold value is undershot, and the PUF can be enabled or restricted depending on the embodiment. It is likewise possible to configure the threshold value for a plurality of intended uses of the PUF 6, and/or different threshold values can be assigned to different intended uses. The use of the PUF is possibly blocked only for some intended uses but is enabled for others on the basis of the comparison result. Specifically, two cryptographic keys could be derived from the PUF. Access to both keys, to only the first key (or to only the second key) or to no key is enabled on the basis of the comparison result.

According to other preferred embodiments, the testing unit can check, during the comparison, whether the response R1 sufficiently matches the PUF response PR1. In order to increase the significance of the comparison, however, the testing unit may also check, during the comparison, for repeated input of the challenge information C1 to the PUF 6, whether the PUF responses PRi generated by the PUF 6 as a result sufficiently match the response R1. The testing unit can likewise check, during the comparison, for a plurality of challenge-response pairs CRi each comprising an item of challenge information Ci and an item of response information Ri associated with the challenge information Ci, whether the PUF responses PRi generated by the PUF 6 on account of the inputs of the challenge information Ci to the PUF 6 sufficiently match the respective responses Ri.

According to preferred embodiments, a PUF subassembly carries out a self-test before access to the PUF functionality is provided (for example for authentication or key determination). A self-test of the PUF 6 is carried out for this purpose using reference data stored in the data memory 7. If this is successful, access to the PUF 6 is enabled.

FIG. 4 shows a flowchart 20 for a preferred embodiment of the inventive method 20 which can be carried out by the circuit unit illustrated in FIG. 3.

The method 20 allows a self-test to be carried out for the circuit unit 1. Method step 21 is used to start the method 20. Access to the PUF 6 is blocked as standard, illustrated by method step 22. In method step 23, the testing unit 5 acquires test data, for example the challenge-response pair CR1. The challenge information C1 from the challenge-response pair CR1 is then input to the PUF 6. The PUF then provides a PUF response PR1. The PUF response PR1 and the response information R1 are then compared by the testing unit 5, illustrated by method step 24. Method step 25 determines a PUF confidence value. For example, the confidence value allows a statement regarding how well the PUF response PR1 and the response information R1 match. A high confidence value corresponds to a good match in this case. If the confidence value exceeds a threshold value, which is checked in method step 26, access to the PUF 6 is enabled in method step 27. However, if the confidence value does not exceed the threshold value, access to the PUF 6 is not enabled in method step 28. Use of the PUF 6 is therefore enabled or restricted on the basis of the comparison result. Method step 29 constitutes the end of the method.

One preferred embodiment of the invention proposes a function test for a PUF. This may be integrated in a PUF unit as a self-test or may possibly also be separate. The function test of the PUF is carried out before use of the PUF or a security functionality of the device, in which the PUF is integrated, is released.

The test can be carried out at different times or for different events:
production
start-up
booting/after applying current
regularly and recurrently during operation, etc., for example at regular intervals of time or in a manner interleaved with the calculation of external “keenly” used challenges (int, ext, int, ext, etc.).

The test may comprise one or more of the following tests:
Determining statistical characteristic variables from a plurality of responses containing identical challenge values (for example Hamming distance: minimum/maximum/mean value/variance/standard deviation of the Hamming distance). These must be in a particular range.
Testing using known test challenge-response pairs: error deviation (determine Hamming distance of the response to a challenge containing the knowing response values and compare with a threshold value. The threshold value is usefully set “more tightly” (more carefully) than required for operation. If a key, for example, is determined from a PUF using a key extractor function, in which case up to 20 bit errors can be corrected for example, a test of the PUF (with other challenge test values) is first of all carried out, in which case a maximum of 10 or 15 bit errors can occur in order to allow further use of the PUF for the key extraction. Alternatively, a first key can also be extracted from a PUF with a first set of challenge values and can be tested using stored reference information. A second (sharp) key is extracted or used only if the first key is identified as valid. In this case too, a “more reserved” error correction (which corrects fewer errors) can be used for the first key in comparison with the extraction of a “sharp” key.

1. A circuit unit (1) comprising a physical unclonable function (6), called PUF (6) below, a testing unit (5) and an information memory (7) for storing at least one challenge-response pair (CR1);
the challenge-response pair (CR1) comprising an item of challenge information (C1) and an associated item of response information (R1); and
the testing unit (5) being configured and/or adapted to prompt an input of the challenge information (C1) to the PUF (6), to use a PUF response (PR1) thereto, which is generated by the PUF (6), and the response information (R1) for a comparison and to enable or restrict use of the PUF (6) on the basis of the comparison result.

2. The circuit unit (1) as claimed in claim 1, the circuit unit (1) being an integrated circuit (1).

3. The circuit unit (1) as claimed in one of the preceding claims, comprising an interface (9) which can be used to access the PUF (6) from the outside.

4. The circuit unit (1) as claimed in one of the preceding claims, the use of the PUF (6) being able to be enabled or restricted by enabling or blocking access to the PUF (6).

5. The circuit unit (1) as claimed in one of the preceding claims, the use of the PUF (6) being able to be enabled or restricted by enabling or blocking the interface (9).

6. The circuit unit (1) as claimed in one of the preceding claims, the use of the PUF (6) being able to be enabled or restricted using a cryptographic parameter determined by the PUF (6), preferably by virtue of a cryptographic key being able to be determined by a fuzzy key extractor, in which case the output of the key can be blocked.

7. The circuit unit (1) as claimed in one of the preceding claims, the testing unit (5) being configured and/or adapted to determine a degree of match during the comparison, which degree of match is compared with a threshold value, and the use of the PUF (6) being enabled or restricted if the determined degree of match reaches, exceeds or undershoots the threshold value.

8. The circuit unit (1) as claimed in claim 7, the threshold value being able to be configured for a plurality of intended uses of the PUF (6), different threshold values being able to be assigned to different intended uses.

9. The circuit unit (1) as claimed in one of the preceding claims, the testing unit (5) being configured and/or adapted to check, during the comparison, whether:
a) the response (R1) sufficiently matches the PUF response (PR1); or
b) for repeated input of the challenge information (C1) to the PUF (6), the PUF responses (PRi) generated by the PUF (6) as a result sufficiently match the response (R1); or
c) for a plurality of challenge-response pairs (CRi) each comprising an item of challenge information (Ci) and an item of response information (Ri) associated with the challenge information (Ci), the PUF responses (PRi) generated by the PUF (6) on account of the inputs of the challenge information (Ci) to the PUF (6) sufficiently match the respective responses (Ri).

10. A method for carrying out a self-test for a circuit unit (1) comprising a physical unclonable function (6), called PUF (6) below, a testing unit (5) and an information memory (7) for storing at least one challenge-response pair (CR1), the challenge-response pair (CR1) comprising an item of challenge information (C1) and an associated item of response information (R1), the method comprising the method steps of:
inputting the challenge information (C1) to the PUF (6);
using a PUF response (PR1) thereto, which is generated by the PUF (6), and the response information (R1) for a comparison carried out by the testing unit (5), use of the PUF (6) being enabled or restricted on the basis of the comparison result.

11. The method as claimed in claim 10, the circuit unit (1) being an integrated circuit (1).

12. The method as claimed in claim 10 or 11, the circuit unit comprising an interface (9) which is used to access the PUF (6) from the outside on the basis of the comparison.

13. The method as claimed in one of claims 10 to 12, the use of the PUF (6) being directly enabled or blocked.

14. The method as claimed in one of claims 10 to 13, the use of the PUF (6) being enabled or restricted by enabling or restricting the interface (9).

15. The method as claimed in one of claims 10 to 14, the use of the PUF (6) being enabled or restricted using a cryptographic parameter determined by the PUF (6), preferably by virtue of a cryptographic key being determined by a fuzzy key extractor, in which case the output of the key can be blocked and the use of the PUF (6) is thus restricted.

16. The method as claimed in one of claims 10 to 15, a degree of match being determined during the comparison,
which degree of match is compared with a threshold value, and the use of the PUF (6) being enabled or restricted if the determined degree of match reaches, exceeds or undershoots the threshold value.

17. The method as claimed in one of claims 10 to 16, the threshold value being configured for a plurality of intended uses of the PUF (6), different threshold values being able to be assigned to different intended uses.

18. The method as claimed in one of claims 10 to 17, a check being carried out, during the comparison, in order to determine whether:
a) the response (R1) sufficiently matches the PUF response (PR1); or
b) for repeated input of the challenge information (C1) to the PUF (6), the PUF responses (PRi) generated by the PUF (6) as a result sufficiently match the response (R1); or
c) for a plurality of challenge-response pairs (CRi) each comprising an item of challenge information (Ci) and an item of response information (Ri) associated with the challenge information (Ci), the PUF responses (PRi) generated by the PUF (6) on account of the inputs of the challenge information (Ci) to the PUF (6) sufficiently match the respective responses (Ri).
